(19) United States
(12) Patent Application Publication
(10) Pub. No.: US 2021/0337766 A1
(43) Pub. Date: Nov. 4, 2021

(54) MULTI-HOUSE FOR PETS

(71) Applicant: Maing Ki PARK, Seoul (KR)

(72) Inventor: Maing Ki PARK, Seoul (KR)

(21) Appl. No.: 17/285,439

(22) PCT Filed: Mar. 22, 2019
(86) PCT No.: PCT/KR2019/003392

§ 371 Date: Apr. 14, 2021

(30) Foreign Application Priority Data
Oct. 16, 2018 (KR) 10-2018-0123419

(51) Int. Cl. A01K 13/00; A01K 1/035

(52) U.S. Cl. CPC A01K 13/001; A01K 1/035

(57) ABSTRACT

The objective of the present invention is to obtain a multi-house for pets, the multi-house performing both simple cleaning and brushing of a pet as necessary after the pet goes outdoors, after the pet is walked, and before the pet goes outdoors while reducing stress of the pet, enabling the pet to look stylish, clean and hygienic, being useable as a house and, specifically, being convenient to move. The present invention has a main body part, an insertable and separable mounting hole and mounting space part formed at the lower end of the rear surface of the main body part, a hygienic cleaning blower capable of being attached to and detached from the mounting hole, and formed so as to selectively supply forced air to the upper or lower part thereof, a door formed at the front thereof, an upper nozzle part and side nozzle parts formed therein and connected to an inner supply nozzle part, a shelf and a handle, which has an adjustable length so as to facilitate portability, formed at the upper portion of the main body part, wheels attached to the lower end thereof so as to enable convenient movement, and a control part formed so as to control a hygienic cleaning device, and thus the present invention is very useful.

### FIELD OF INVENTION

The present invention relates to a multi-functional house (abbrev. to “multi-house”) for companion animals and, more particularly, a multi-house for companion animals (“pets”) which enables the pet to look stylish, clean and hygienic, while reducing stress to the pet, simultaneously washing and brushing before or after going out, after walking and/or when necessary, specifically, which is usable as a pet house and is convenient to move.

### BACKGROUND OF INVENTION

In general, in order to wash pets such as dogs, cats, etc., an owner manually washes the pet's body using water and shampoo.

However, there are problems in managing a pet that is difficult for the owner to wash and washing takes a lot of time because the pet is usually resistant.

Further, such a typical washing method as described has a problem in that a lot of water and detergent are used.

Korean Utility Model Registration No. 20-0357835 published on Jul. 31, 2004 disclosed a pet washing device which is based on a conventional dog washing device and is provided with a far-infrared ray generator, an ozone generator and a separate respirator, so as to remove odor, sterilize and supply fresh air while not interfering with breathing of the dog pet during washing and drying.

It is clearly understood that the above previously registered design is relatively useful as compared to the conventional dog pet washing device in which a washing tank is liable to be dirty and which has no choice but to impede the breathing of the dog pet during washing or drying.

However, as shown in the previously registered design, since a machine room in which different machinery parts are installed is separately provided in a right space and a back space of the washing device, a size of the washing device is not only increased but also a mounting space is restricted due to the same. Specifically, a door is provided in the front side and occupies a large rotational space for opening and closing the door, thus entailing a problem in that, when a dog pet is put in the washing device, the dog may often escape the washing tank before closing the front door.

Further, as shown in the previously registered design, the washing device is closed in all directions and a fan is installed only on an upper portion, whereby hot air or external air supplied by a hot air fan and an air blower is forcibly discharged from the bottom to the top, thus hindering breathing of the dog pet.

### SUMMARY OF INVENTION

### Technical Problem to be Solved

Therefore, in order to solve the above problems,

an object of the present invention is to provide a multi-house for a companion animal (“pet”) that is usable as a house of the pet, enables the pet to look stylish while caring for the pet in a clean and hygienic state.

Another object of the present invention is to provide a multi-house for pets, which is provided with a detachable hygienic washing blower.

A still further object of the present invention is to provide a multi-house for pets, which is usable as a house and is provided with wheels for movement and/or with a detachable heavy hygienic washing blower.

### Technical Solution

In order to accomplish the above purposes, the present invention provides a multi-house for pets, which may include:

a main body; a mounting member and a mounting space provided at a lower end of a rear surface of the main body, which are insertable and removable from the main body; a hygienic washing blower unit which is detachable from the mounting member and formed to forcibly feed air; and a door (“front door”) provided at the front side of the washing device.

Further, the hygienic washing blower unit may include: a main blower having a through-hole formed in the center portion and a plurality of wing blades arranged around a rim surface thereof; a main motor connected to rotate the main blower; a forced draft (FD) blower including a fixing bracket to secure the main motor; and a heater unit that includes a heating lamp to increase a temperature of air discharged to the main blower in order to generate warm air, and a lower fixing support provided with fixing clamps at both sides thereof to secure an electrode.

### Effect of Invention

The present invention has effects of providing a multi-house for pets that is usable as a house for the pet and enables the pet to look stylish while showering the pet in a clean and hygienic state.

Further, the present invention is very useful since the hygienic washing blower unit can be detached from the multi-house to reduce weight of multi-house when moving or going outside and, in particular, only the necessary parts can be replaced in case of failure or replacement.

### BRIEF DESCRIPTION OF DRAWINGS

FIG. 1 is a perspective view illustrating the multi-house for companion animals (“pets”) according to a preferred embodiment of the present invention.

FIG. 2 is a perspective view illustrating a state of the multi-house for pets according to the present invention, in which the front door is opened.

FIG. 3 is a perspective view illustrating a combination of the main body and the hygienic washing blower unit according to the present invention.

FIG. 4 is a cross-sectional view of air flow in the multi-house for pets according to the present invention.

FIG. 5 is an exploded perspective view illustrating the multi-house for pets according to the present invention.

FIGS. 6 and 7 are operational state diagrams of the multi-house for pets according to the present invention.

FIG. 8 is an assembled perspective view illustrating the multi-house for pets according to the present invention.

FIG. 9 is an operational state diagram illustrating wireless communication of the multi-house for pets according to the present invention.

FIG. 10 is a perspective view illustrating the hygienic washing blower unit according to the present invention.

FIG. 11 is a use state diagram illustrating the front door of the multi-house for pets according to the present invention.

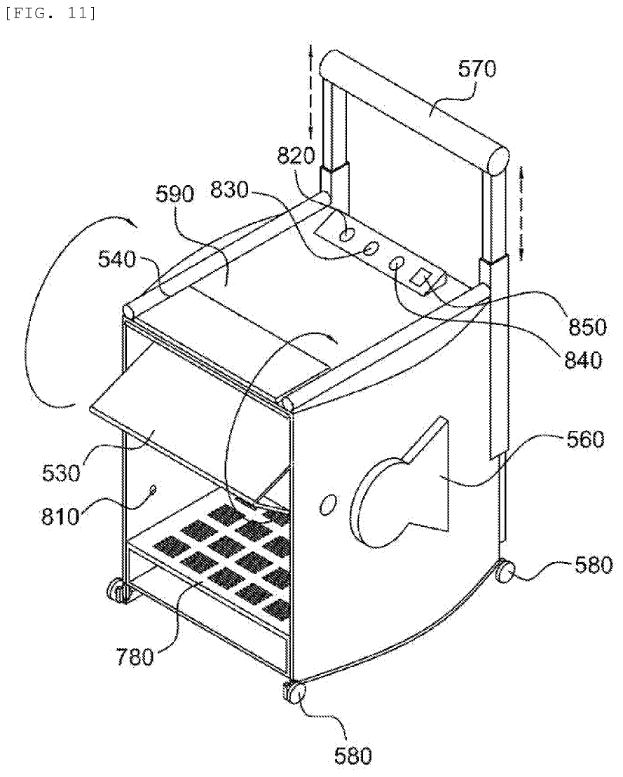

FIGS. 12a and 12b are cross-sectional views illustrating a use state of the multi-house for pets according to another embodiment of the present invention.

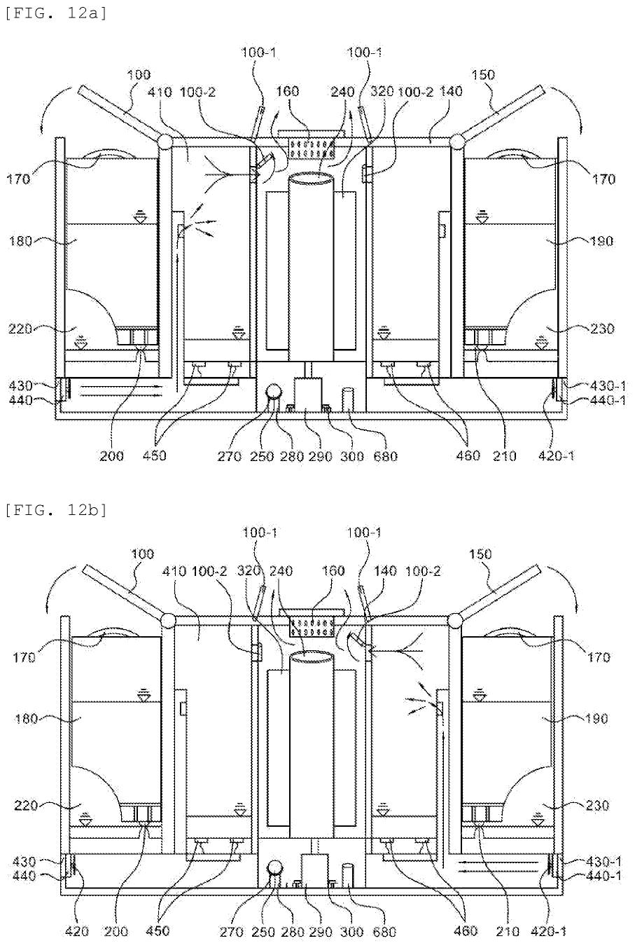

### DETAILED DESCRIPTION OF PREFERRED EMBODIMENTS OF INVENTION

Advantages and features of the present invention, and a method for achieving the same will be clarified with reference to the following embodiments described in detail. The present invention is not limited to the embodiments described herein and may be embodied in other forms. In fact, the embodiments introduced herein are intended to ensure that the disclosed subject matters are thoroughly and completely understood, and are provided so that the spirit of the present invention is sufficiently conveyed to those skilled in the art. The terms used in this application are only used to describe specific embodiments and are not intended to limit the present invention. Singular expressions may also include plural expressions unless the context clearly indicates otherwise. Unless otherwise defined, all terms used herein including technical or scientific terms have the same meaning as commonly understood by those skilled in the art to which the present invention pertains. Such terms defined in a commonly used dictionary should be interpreted as having meanings consistent with meanings in the context of related technologies, and should not be interpreted as ideal or excessively formal meanings unless explicitly defined in the present application.

Preferred embodiments of the present invention will be described in detail with reference to the accompanying drawings.

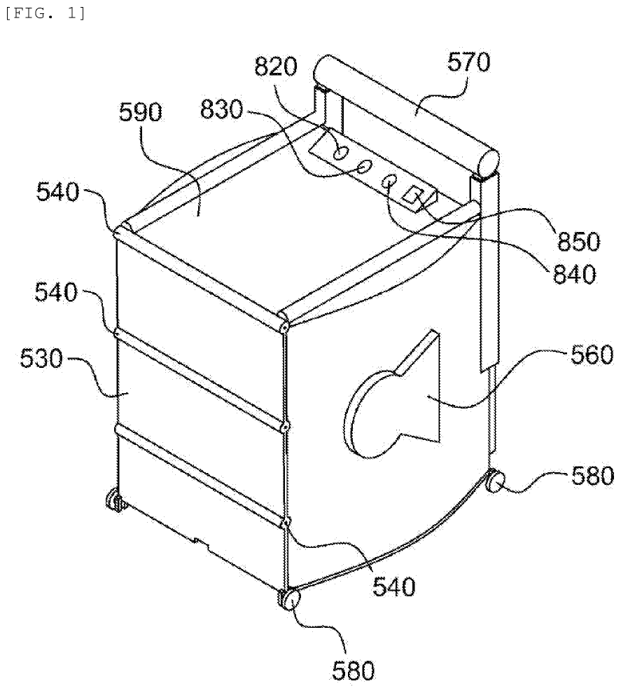

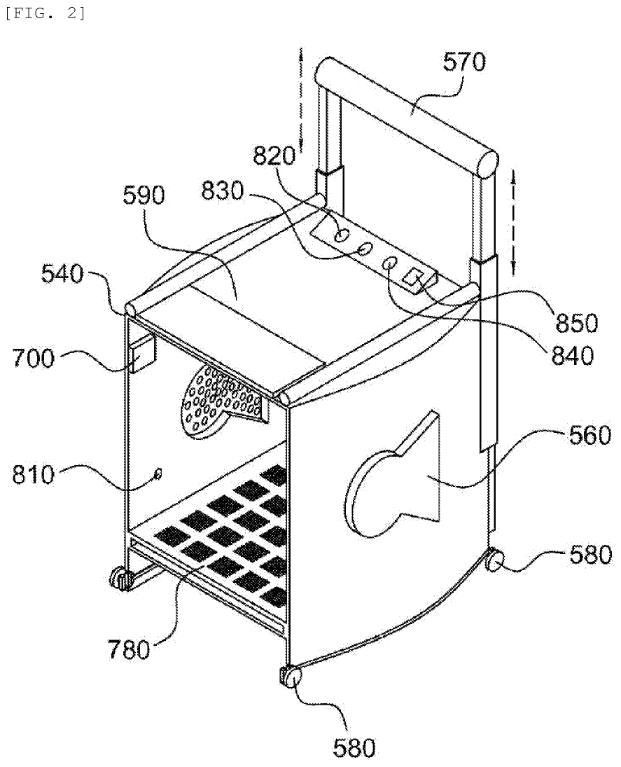

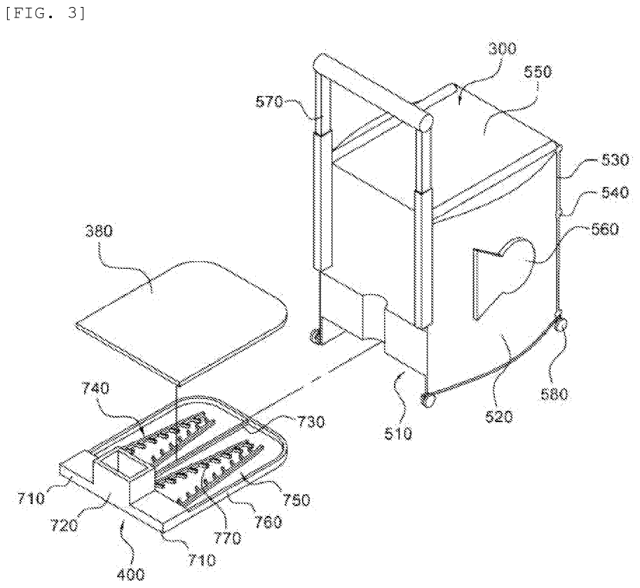

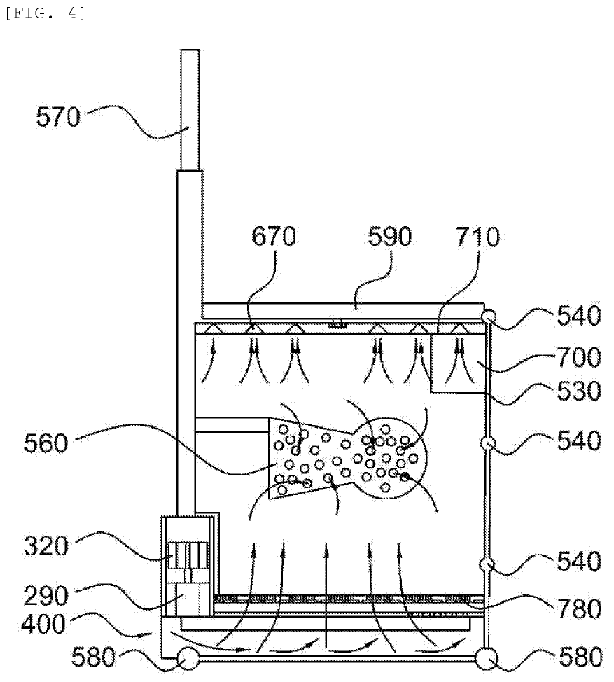

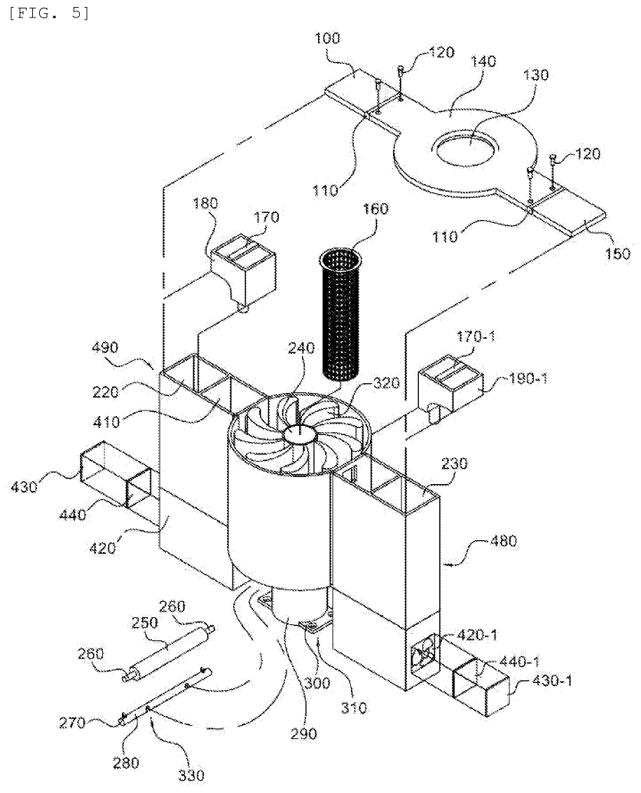

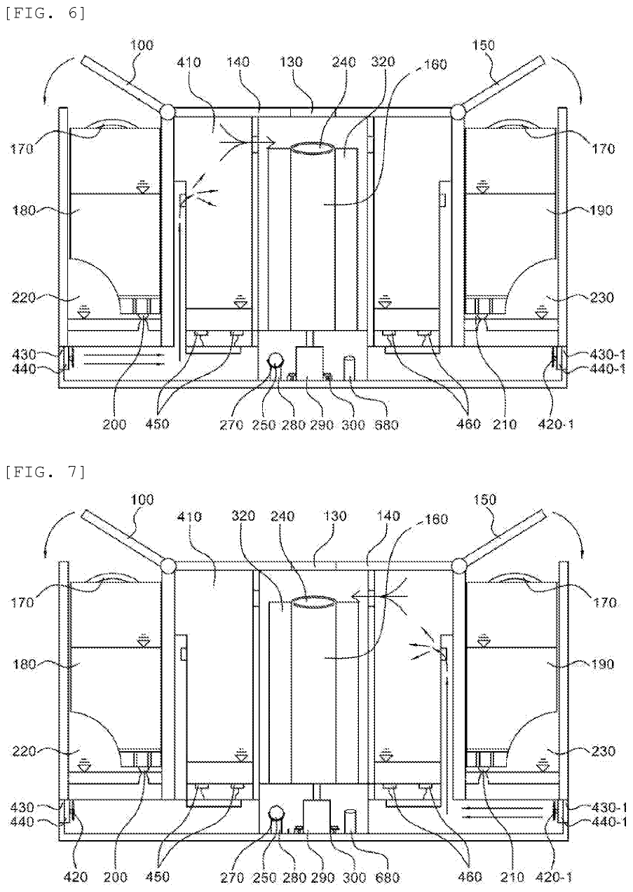

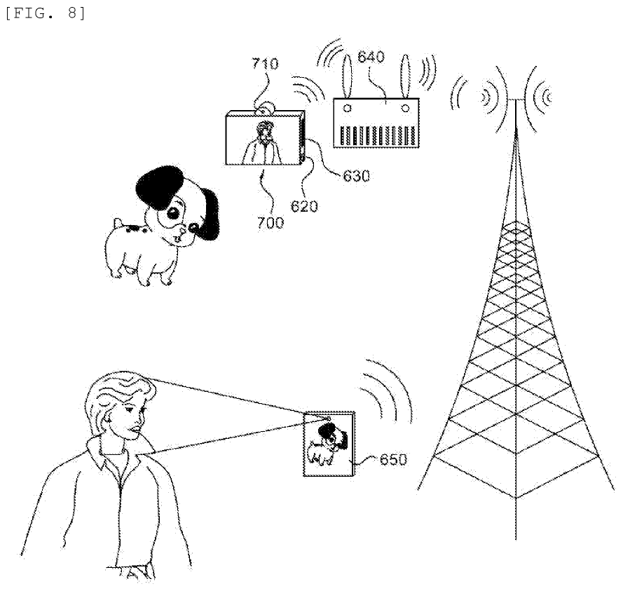

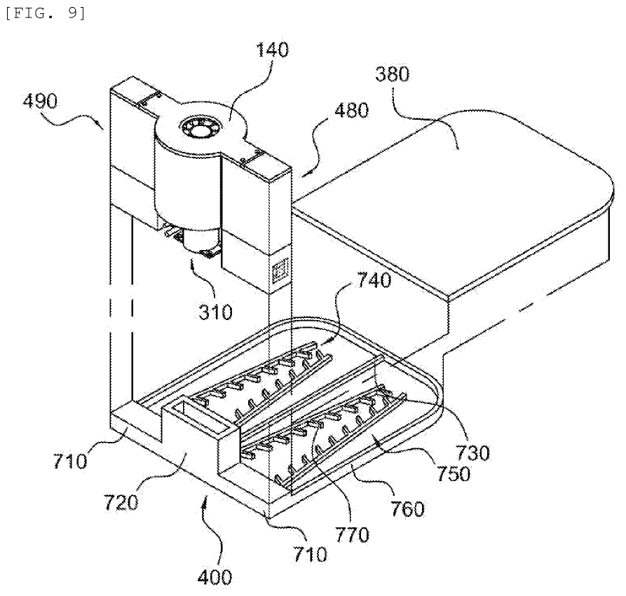

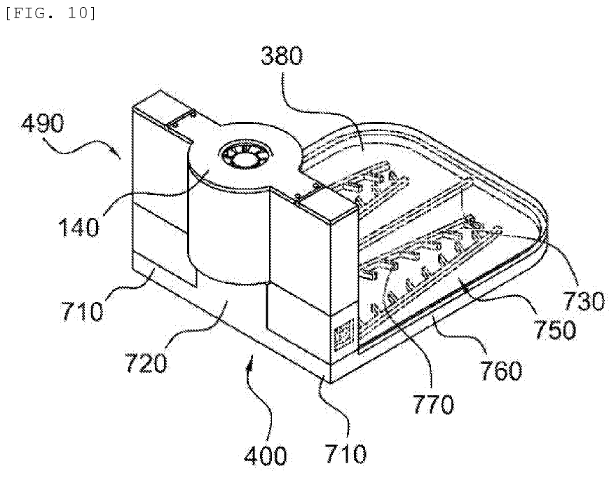

According to detailed information for carrying out the present invention as shown in FIGS. 1 to 10, the multi-house for pets according to the present invention may include:

a main body 500; a mounting member 510 and a mounting space 520 provided at a lower end of a rear surface of the main body, which are insertable and removable from the main body; and a hygienic washing blower unit 400 which is detachable from the mounting member and includes a main blower rotating in normal and reverse directions to forcibly feed air from an upper portion to a lower portion or vice versa, a main motor to control a rotational speed of the main blower, and a heater unit to supply warm air.

The multi-house for pets according to the present invention may further include: a front door 530 provided in the front of the main body 500; an upper nozzle member 670 and a side nozzle member 560 connected to an internal feed nozzle; a shelf and a length-adjustable handle 570 for convenient movement, which are provided on an upper portion of the main body; a wheel member 580 coupled to the bottom thereof for convenient movement; and a control unit connected to the main body by a wire or a connection jack in order to control the hygienic washing blower unit 400.

The front door may be folded in two or three stages by a hinge 540, and the upper nozzle member 670 and the side nozzle member 560 connected to the internal feed nozzle may be included in the front door.

Further, the shelf 590 as well as the handle 570 in a foldable form to facilitate movement may be provided on the top of the main body, while the wheel member 580 may be coupled to the bottom thereof, thereby conveniently moving the multi-house for pets.

The front door 530 may have a hinge 540 on a folding part at which the front door is folded in two or three stages, thus being laid over the shelf. Further, a magnet or a hook may be provided at the end of the front door to secure the front door.

In addition, the multi-house for pets according to the present invention may further include a display unit 700 to communicate with the pet, wherein the display unit 700 is provided with a camera 710 to photograph an inner space, and a microphone 620 and a speaker 630 to listen to phone-call voice as well as music. Specifically, cultural music, water noise and/or bird sounds may be prepared to provide a comfortable house in which the pet is soothed and has a sense of security or stability during bathing.

The display unit 700 may be connected to an external smartphone 650 through a communication RAM 640 that wirelessly connects with the display unit, so as to form a wireless data unit by which images can be viewed simultaneously with communication.

The hygienic washing blower unit 400 may include:

a main blower 320 having a through-hole 240 formed in the center portion thereof and a plurality of wing blades arranged around a rim surface thereof; a main motor 290 connected to rotate the main blower; a forced draft (FD) blower 310 including a fixing bracket 300 to secure the main motor; a heater unit 330 that includes a heating lamp 250 to increase a temperature of air discharged to the main blower 320 in order to generate warm air, and a lower fixing support 280 provided with fixing clamps 270 at both sides thereof to secure an electrode 260 of the heating lamp 250; and an anion generator 680.

At the top of the through-hole 240, left and right lids 110 and 150 may be provided on left and right sides, while securing a central lid 140 by hinges 110 and bolts 120. Further, a vent 130 may be formed at the center of the central lid to discharge or intake forced air.

In another embodiment of the present invention, a one-way outlet door 100-1 may be provided on left and right sides of the central lid 140. The one-way outlet door 100-1 may be configured to be opened only when a detergent feed member 490 or a washing water feed member 480 is operated. Alternatively, the one-way outlet door 100-1 may be configured to be closed by load and opened when air pressure is generated.

Further, another one-way outlet door 100-2 may be provided on each side wall of the detergent feed member 490 and the washing water feed member 480 and have a configuration in which the door is closed due to internal pressure when the main blower is strongly rotated, while being opened by an operational pressure of the detergent feed member 490 or the washing water feed member 480 at a low rotational speed.

According to the present invention, the detergent feed member 490 and the washing water feed member 480 may be provided on left and right sides of the FD blower 310, respectively. In this regard, the detergent feed member 490 may include: a detergent container 180; a lower reservoir projection 200 formed to discharge a predetermined amount of the detergent; two ultrasonic oscillators 450 present in a reservoir, which are configured to discharge the detergent in the form of microfine liquid detergent molecules; and a detergent discharge blower fan 420 to discharge the microfine liquid detergent, which is provided with a filter 440 and a case 430.

The washing water feed member 480 may include: a washing water container 190-1; a lower reservoir projection 210 formed to discharge a predetermined amount of the washing water; two ultrasonic oscillators 460 formed to discharge the washing water in the form of microfine water molecules; and a washing water discharge blower fan 420-1 to discharge the microfine water molecules, which is provided with a filter 440-1 and a case 430-1.

The detergent feed member 490, the washing water feed member 480 and the FD blower 310 may be seated in a rim 710 having a protruding structure. The hygienic washing blower unit may further include: a seating projection sheet 720 protruding upward in the center portion; an air distribution base plate 760 disposed in the front portion; a central guide bar 730 disposed in the center of the base plate 760 so as to uniformly discharge air upward; and left and right triangular guide bars 740 and 750 which are disposed on left and right sides of the central guide bar 730, respectively, and have a narrowing width in the front direction so as to increase a pressure of the air discharged from the main blower 320.

A plurality of auxiliary guide bars 770 may be provided on each of the left and right triangular guide bars 740 and 750 as well as the central guide bar 730, thereby uniformly applying air pressure throughout the hygienic washing blower unit.

The auxiliary guide bars 770 may be disposed on lateral sides or the center of the left and right triangular guide bars 740 and 750, while a vertical support 380 having a plurality of perforations may be formed on the top of the hygienic washing blower unit.

According to the present invention, the hygienic washing blower unit 400 having the detergent feed member 490 and the washing water feed member 480 may further include a heating lamp 250 to supply warm (or hot) air while preventing the temperature from decreasing, and an anion generator 680 provided at the lower end of the blower unit 400 in order to increase sterilizing ability of the air, thereby sterilizing pathogens and removing odors of the pet.

Further, the multi-house for pets according to the present invention may further include a perfume bottle and a spray nozzle to spray perfume such as herbal and floral fragrances or aromatics during drying.

The control unit 800 may include: an on-off switch 840; a camera 710 provided to photograph the inner space; a display unit 700 provided with a microphone 620 and a speaker 630 in order to listen to phone-call voice and music; and a data transmitting/receiving unit connected to an external smartphone 650 through a communication RAM 640 that wirelessly connects with the display unit 700, thereby viewing images simultaneously with communication. By the smartphone, it is possible to check a companion animal inside the space and, if necessary, to make a call through video and sound.

According to the present invention, the multi-house for pets may further include: a sensor 810 for checking the presence or absence of a pet in a pet accommodation space in the main body; a menu selection switch 820 for selecting “air care”, “hygienic care”, “warm care”, “cool care”, etc. that may be selected while being sensed by the sensor; and an operation time selection member 830 and a temperature control member 840 for a user to select desired times such as 5 minutes, 10 minutes, 15 minutes, 30 minutes, 1 hour, etc.

In an automatic selection mode, dust adhered to the pet from the outside after going out may be removed with strong air fed from the lower portion according to “air care”. As such, the air care may allow the hygienic washing blower unit 400 to rotate normally so that the main blower of the hygienic washing blower unit 400 can repeatedly blow air with strong rotation or moderate rotation to inject air from the lower portion to the upper portion, thereby removing the dust adhered to the hair of the pet. Further, a filter screen 160 may be removably disposed to remove foreign matter.

As described above, “hygienic care” may allow the main blower of the hygienic washing blower unit 400 to rotate reversely to inject the detergent instead of water washing, whereby microfine detergent molecules formed and sprayed by the ultrasonic oscillator 450 in the detergent feed member may be strongly discharged through the detergent discharge blower fan 420. Microparticles of the detergent may be formed to wet or moisten the hair so that the microfine detergent can decompose or remove the dust and/or dirt adhered to the hair. In this case, after cleaning, the main blower may rotate to circulate internal air in order to remove internal moisture, thereby eliminating a cloudy state inside the space. Herein, it is preferable to provide an additional outlet through which the internal moisture is discharged to the outside.

After cleaning as described above, the ultrasonic oscillator provided in the washing water feed member to convert water into microparticles may be operated to prepare microfine water particles, and the washing water discharge blower fan 420-1 may be operated to discharge the microfine water particles to the outside. In this case, clean water is used to separate or remove decomposed dirt and dust from the hair. As described above, after washing in a clean state, the hair may be completely dried with warm or cold air.

That is, after cleaning and washing are completed as described above, the main blower may be rotated to strongly blow air from the lower portion to the upper portion so as to shake off or remove impurities such as hair, dirt, etc. After air flows from the lower portion to the upper portion, the main blower may rotate reversely to change air flow from the upper portion and the lateral portion to the lower portion. Further, the air flowing from the lower portion to the upper portion may evenly dry the hair up and down.

In addition, according to the present invention, since the heavy hygienic washing blower unit 400 is detachable, the main body may be carried and moved alone when going out or on vacation.

1. A multi-house for companion animals (“pets”) to strongly supply external air and clean the pet, comprising:
a main body; a mounting member and a mounting space provided at a lower end of a rear surface of the main body, which are insertable and removable from the main body; and a hygienic washing blower unit which is provided to be detachable from the mounting member and includes a main blower rotating in normal and reverse directions to forcibly feed air from an upper portion to a lower portion or vice versa, a main motor to control a rotational speed of the main blower, and a heater unit to supply warm air, and
further comprising:
a front door provided in the front of the main body; an upper nozzle member and a side nozzle member connected to an internal feed nozzle; a shelf and a length-adjustable handle for convenient movement, which are provided on an upper portion of the main body; a wheel member coupled to the bottom thereof for convenient movement; and a control unit connected to the main body by a wire or a connection jack in order to control the hygienic washing blower unit.

2. The multi-house for pets according to claim 1, wherein the main body include a display unit to communicate with the pet, and wherein the display unit is provided with a camera to photograph an inner space, and a microphone and a speaker to listen to phone-call voice as well as music, and wherein the display unit is connected to an external smartphone through a communication RAM that wirelessly connects with the display unit, so as to view images simultaneously with communication.

3. The multi-house for pets according to claim 1, wherein the hygienic washing blower unit includes:
a main blower having a through-hole formed in the center portion and a plurality of wing blades arranged around a rim surface thereof;
a main motor connected to rotate the main blower;
a forced draft (FD) blower including a fixing bracket to secure the main motor;
a heater unit that includes a heating lamp to increase a temperature of air discharged to the main blower in order to generate warm air, and a lower fixing support provided with fixing clamps at both sides thereof to secure an electrode of the heating lamp;
an anion generator provided at the lower end of the hygienic washing blower unit to add anions to the discharged air; and
a detergent feed member including ultrasonic oscillators to finely inject the detergent and a washing water feed member including ultrasonic oscillators to finely inject the washing water, wherein the detergent feed member and the washing water feed member are disposed on left and right sides of the FD blower, respectively.

4. The multi-house for pets according to claim 1, wherein the hygienic washing blower unit includes:
and a washing water feed member provided with ultrasonic oscillators to finely inject the washing water, which are disposed on left and right sides of the FD blower, respectively, wherein the detergent feed member includes: a detergent container provided with a handle and an outlet at the bottom thereof; a lower reservoir projection formed to discharge a predetermined amount of the detergent; two ultrasonic oscillators present in a reservoir, which are configured to discharge the detergent in the form of microfine liquid detergent molecules; and a detergent discharge blower fan to discharge the microfine liquid detergent, which is provided with a filter and a case;
wherein the washing water feed member includes: a washing water container provided with a handle and an outlet; a lower reservoir projection formed to discharge a predetermined amount of the washing water; two ultrasonic oscillators formed to discharge the washing water in the form of microfine water molecules; and a washing water discharge blower fan to discharge the microfine water molecules, which is provided with a filter and a case;
a rim having a protruding structure in which the detergent feed member, the washing water feed member and the FD blower are seated;
a seating projection sheet protruding upward in the center portion;
an air distribution base plate disposed in the front portion;
a central guide bar disposed in the center of the base plate so as to uniformly discharge air upward;
left and right triangular guide bars which are disposed on left and right sides of the central guide bar, respectively, and have a narrowing width in the front direction so as to increase a pressure of the air discharged from the main blower;
auxiliary guide bars provided on lateral sides or the center of the left and right triangular guide bars; and
a vertical support having a plurality of perforations provided on the top of the hygienic washing blower unit.

5. The multi-house for pets according to claim 1, further comprising:
left and right lids formed on left and right sides at top of the through-hole in the hygienic washing blower unit;
a central lid fixed by hinges and bolts while having a vent therein;
an one-way outlet door provided on left and right sides of the central lid, which is configured to be opened only when a detergent feed member or a washing water feed member is operated;
another one-way outlet door provided on each side wall of the detergent feed member and the washing water feed member, and having a configuration in which the door is closed due to internal pressure when the main blower is strongly rotated, while being opened by an operating pressure of the detergent feed member or the washing water feed member at a low rotational speed.

6. The multi-house for pets according to claim 1, wherein the front door is folded in two or three stages and has a hinge on a folding part, thereby being folded when the front door is opened.
